(19) United States
(12) Patent Application Publication
(10) Pub. No.: US 2006/0244382 A1
(43) Pub. Date: Nov. 2, 2006

(54) Discharge bulb

(75) Inventor: Kiyoshi Okishima, Kanagawa (JP)

Correspondence Address: Patrick G. Burns;GREER, BURNS & CRAIN, LTD., Suite 2500, 300 South Wacker Drive, Chicago, IL, 60606, US

(73) Assignee: SANYO TECNICA CO., LTD.

(21) Appl. No.: 11/392,002

(22) Filed: Mar. 29, 2006

(30) Foreign Application Priority Data
Apr. 28, 2005 (JP) 2005-131084

(51) Int. Cl. H01J 61/36; H01J 17/18

(52) U.S. Cl. 313/623; 313/624; 313/625

(57) ABSTRACT

A protection cap is mounted to the top end part of a discharge bulb for a vehicle.

### BACKGROUND OF THE INVENTION

1. Field of the Invention

The present invention relates to a light blocking plate (hereinafter it is referred to as a shade) used for a high intensity discharge lamp (hereinafter it is referred to as a HID (high intensity discharge bulb) used for a vehicle such as an automobile and a motorcycle.

2. Description of the Related Art

Recently, in place of an incandescent bulb or a halogen bulb, a discharge type light source with a low power consumption and a high luminance, so-called HID bulb has appeared. In the case of mounting the HID bulb to a head light housing, due to the structure of the HID bulb, there is a limitation of mounting the same in the head light housing while maintaining a specific position. Moreover, as in the case of the incandescent bulb or the halogen bulb, the mounting position with respect to the vertical and horizontal directions is limited due to the relationship between the light distribution at the time of high beam and low beam.

Hereinafter, the conventional structure will be explained specifically.

For the head light housing for mounting the HID bulb, various kinds of structures such as those “storing a shade”, “without a shade”, requiring “a top shade” and not requiring the same, as shown in FIGS. 3A, and 4A have been proposed. To deal with this situation, HID bulb unit having shapes as shown in FIGS. 3B and 4B has been proposed. These HID bulb units are mounted to each head light housing. Specifically, the shade has a structure comprising a top shade 2 and an under shade 6 so as to be detached as needed from the lamp unit.

FIGS. 3A and 3B show a case wherein the HID bulb is mounted to a head light housing 41 storing a shade 1 with a front wall 31. As shown in FIG. 3B, the lamp unit 21 is mounted to the head light housing 41 having the shade 1.

FIG. 4 shows a case wherein a shade having front wall is not provided to the head light housing 42, or even in the case a shade is provided, a light beam is blocked only partially. In this case, as shown in FIG. 4B, the lamp unit 22 having the top shade 2 and the under shade 6 is assembled in the head light housing 42.

FIG. 5 is a perspective view showing the conventional structure of a HID bulb unit with the top shade 2 and the under shade 6.

In FIGS. 3-5, the numeral 7 denotes a flange of HID bulb unit, and the numeral 8 denotes a driving part.

The role of the top shade 2 is to block a random reflection light beam output from the top end part of the HID bulb 5 and to block a direct light emission leaked from the head light so as not to be of a high luminance partially for preventing glare.

As a head lamp for an automobile having a shade, Japanese Unexamined Patent Publication (KOKAI) No. 2002-373509, for example, is known.

However, the above-mentioned role of the shade is to block a light beam. Moreover, although the shade should be provided adjacent to the HID bulb, the temperature of the vicinity of the HID bulb emitting a light beam and heat becomes as high as about 200 ° C. so that a metal shade should be employed from the viewpoint of the heat resistance. Moreover, for the HID bulb, a high voltage of about 20,000 (V) is applied at the time of starting the drive so that a high voltage is supplied from a metal electrode of the HID bulb top end part. Therefore, a problem is involved in that a metal shade tends to generate the leakage discharge. Therefore, a countermeasure has been taken by maintaining the distance between the electrode and the shade, and mounting the shade not to be grounded.

### SUMMARY OF THE INVENTION

The present invention has been achieved in view of the above-mentioned points, and an object thereof is to provide a novel discharge bulb capable of blocking the random reflection light beam leaked from the top end part of the HID bulb and preventing the leakage discharge (leak discharge) from the HID bulb top end part to the shade, to be attached to various head lamp housings.

In order to achieve the above-mentioned objects, the present invention basically adopts the technological configurations mentioned below.

The first aspect of the present invention is a discharge bulb for a vehicle, wherein a protection cap is mounted to a top end part of the discharge bulb.

The second aspect of the present invention is that the protection cap is mounted by closely contacting to the top end part of the discharge bulb integrally.

The third aspect of the present invention is that the protection cap is formed with a resin or a ceramic having a insulation property.

Since the discharge bulb of the present invention has the above-mentioned configurations, random reflection can be reduced in a simple structure, and leakage discharge (leak discharge) by a high voltage can be prevented. Moreover, compared with the conventional configuration, owing to the simple structure, detachment can be carried out in a short time, the production cost can be reduced, and thus it is economical. Furthermore, since it can be mounted to various kinds of head lamp housings, it is highly convenient.

### BRIEF DESCRIPTION OF THE DRAWINGS

FIG. 1 is a diagram showing the structure of a first embodiment of the present invention;

FIGS. 2A and 2B are diagrams showing the structure of a second embodiment of the present invention;

FIGS. 3A and 3B are diagrams showing the mounting structure of a conventional HID bulb unit in the case of not requiring the top shade;

FIGS. 4A and 4B are diagrams showing the mounting structure of a conventional HID bulb unit in the case of requiring the top shade; and

FIG. 5 is a diagram showing the structure of a conventional HID bulb unit with a shade mounted.

### DETAILED DESCRIPTION OF THE PREFERRED EMBODIMENT

Next, preferred embodiments of the present invention will be explained with reference to the drawings.

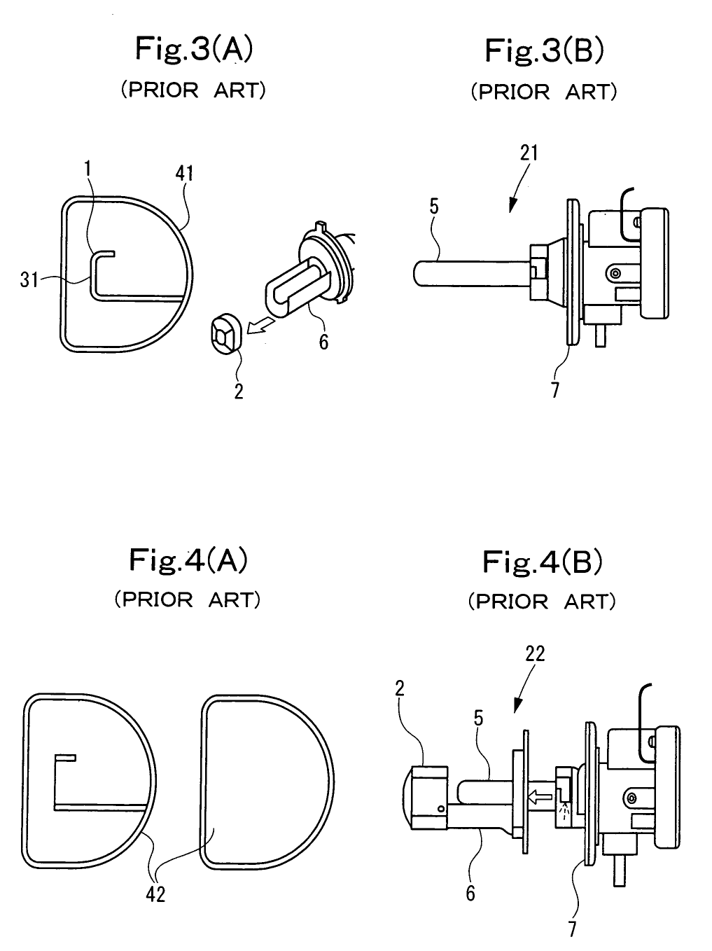

The same numerals are applied to the same portions as in FIGS. 3A to 5 and explanation thereof is not repeated.

### First Embodiment

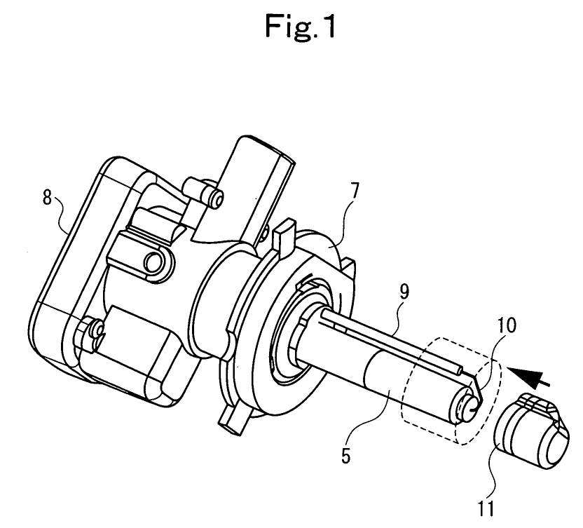

FIG. 1 is a diagram showing a first embodiment of the present invention.

In FIG. 1, the numeral 11 denotes a cap type top shade (protection cap). The cap type top shade 11 is provided so as to cover the top end portion of the a HID bulb 5 including a lead line 10 and a lead line insulation pipe 9 elongating from the top of the HID bulb 5. Since the cap type top shade 11 is closely contacted to the HID bulb 5 which generates heat to about 200 ° C. at the time of light emission, a high heat resistance resin is used therefor. For example, a liquid crystalline polyester resin LCP is preferable. The load deflection temperature of the liquid crystalline polyester resin LCP is 339 to 354 ° C.

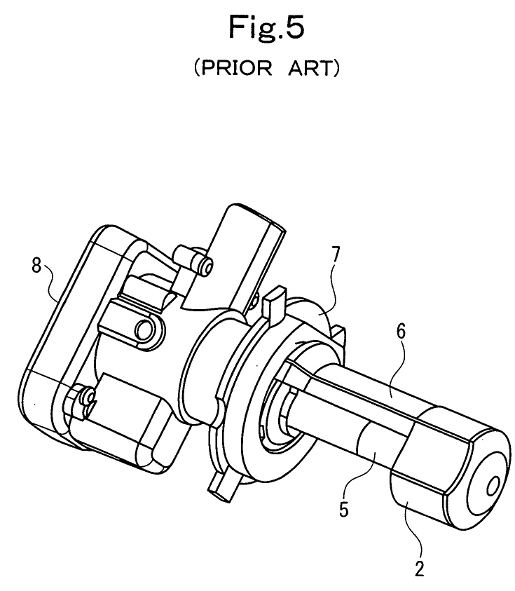

Furthermore, since the resin has a high insulation property, it can prevent the leakage discharge which can be generated by the starting voltage of about 20,000 (V) to be applied to the HID bulb 5. Moreover, the top shade 11 may be closely contacted to the top end part of the HID bulb 5 so as to have an integrated structure so that a light weight and a small size can be achieved compared with the conventional top shade. The HID bulb 5 having the cap type top shade 11 of the present invention can be adopted for the various kinds of the head lamp housings such as the conventional configurations explained with reference to FIGS. 3A, 3B, 4A and 4B.

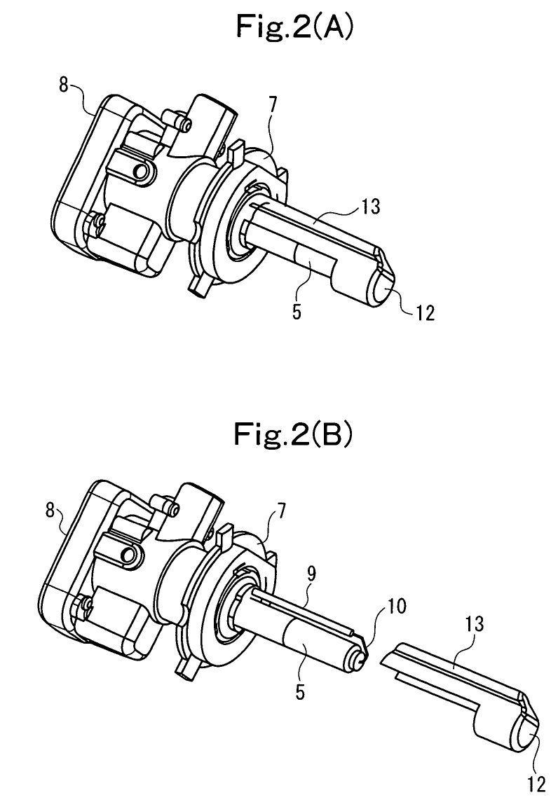

FIGS. 2A and 2B are diagrams showing a second embodiment of the present invention.

Although the cap type top shade 11 is formed with a high insulation, high heat resistant resin in the first embodiment, it is formed with a ceramic in the second embodiment.

In the second embodiment, a cap type top shade 12 and an under shade 13 for covering the lead insulation pipe 9 are made of a ceramic integrally. In this case, the cap type top shade 12 and the under shade 13 may be provided either integrally or separately.

Also in this case, the same effects as in the case of using a high insulation, high heat resistant resin, can be achieved.

The present invention is particularly preferable for a high luminance discharge lamp used for a vehicle such as an automobile and a motorcycle.

What is claimed is:

1. A discharge bulb for a vehicle, wherein a protection cap is mounted to a top end part of said discharge bulb.

2. The discharge bulb according to claim 1, wherein said protection cap is mounted by closely contacting to said top end part of said discharge bulb integrally.

3. The discharge bulb according to claim 1, wherein said protection cap is formed with a resin or a ceramic having a insulation property.
